(19) United States
(12) Patent Application Publication
(10) Pub. No.: US 2006/0231126 A1
(43) Pub. Date: Oct. 19, 2006

(54) Electrical sensor device for the level of the washing water in a washing machine, in particular in a dish-washing machine

(75) Inventor: Michele Farano, Torino (IT)

Correspondence Address: SUGHRUE MION, PLLC, 2100 PENNSYLVANIA AVENUE, N.W., SUITE 800, WASHINGTON, DC, 20037, US

(73) Assignee: ELBI INTERNATIONAL S.P.A.

(21) Appl. No.: 11/389,257

(22) Filed: Mar. 27, 2006

(30) Foreign Application Priority Data
Mar. 25, 2005 (IT) TO2005U000040

(51) Int. Cl. B08B 3/00

(52) U.S. Cl. 134/58 D; 134/56 D

(57) ABSTRACT

The device comprises at least one electrical air pressure threshold sensor, with a body which has an inlet connector; a support structure intended to be fixed in the machine, and to which the body of the pressure sensor is fixed; and at least one duct having one end coupled to the inlet connector of the pressure sensor, and the other end extending into the washing chamber or tub of the machine in such a way that when the level of the washing water in the chamber or tub increases, the water is capable of causing air to be trapped in the duct. The least one duct comprises a length of flexible tube, coupled to the inlet connector of the associated pressure sensor and curved and joined to the support structure in such a way as to form a loop which extends higher than the body of the pressure sensor, and which then continues downwards in the direction of the washing chamber or tub.

The present invention relates to an electrical sensor device for the level of the washing water in a washing machine, and in particular in a dish-washing machine.

It is an aim of the invention to produce a sensor device for the level of the washing water which is simple and economic to manufacture and which is in particular suitable for operation with the air pressure sensor placed at a lower level than the maximum level that can be reached by the washing water in the machine.

These and other aims are achieved according to the invention with a sensor device comprising

at least one electrical air pressure threshold sensor, with a body which has an inlet connector for an air pressure to be detected, and capable of providing an electrical signal when said pressure exceeds a predetermined threshold value;

a support structure intended to be fixed in the machine, and to which the body of said pressure sensor is fixed; and

at least one duct having one end coupled to the inlet connector of the pressure sensor, and the other end extending towards the washing chamber or tub of the machine in such a way that when the level of the washing water increases, said washing water is capable of causing a quantity of air to be trapped in said duct, wherein the said duct comprises a length of flexible tube, coupled to the inlet connector of the pressure sensor and curved and joined to the aforesaid support structure in such a way as to form a loop which extends higher than the body of the pressure sensor and which then continues downwards in the direction of the washing chamber or tub.

The body of the pressure sensor is conveniently fixed to the support structure in such a way that the axis of its inlet connector forms an angle with respect to the vertical.

In one embodiment, the level sensor device according to the invention comprises a pair of air pressure sensors, having respective different threshold values, and fixed in an arrangement horizontally adjacent to the aforesaid support structure; there being coupled to the inlet connectors of the sensors respective lengths of flexible tube, curved in such as way as to form respective loops above the bodies of the corresponding sensors. In that case the pressure sensors are conveniently fixed to the support structure in such a way that the respective inlet connectors extend upwards, in proximity to each other, and the associated lengths of flexible tube form the respective loops following paths that are symmetrical relative to a vertical plane intermediate between the two sensors.

In the device according to the invention, the risk of uncoupling of the flexible tube or tubes from the support structure is reduced, compared with the known devices. Moreover, there is no need for welds, which may be potential sources of problems. Finally, the pressure sensor or sensors are coupled to the detection zone (air trap) directly, without intermediate connections.

Further characteristics and advantages of the invention will become clear from the following detailed description, provided solely by way of non-limiting example, with reference to the appended drawing, which shows a front view of a device according to the invention.

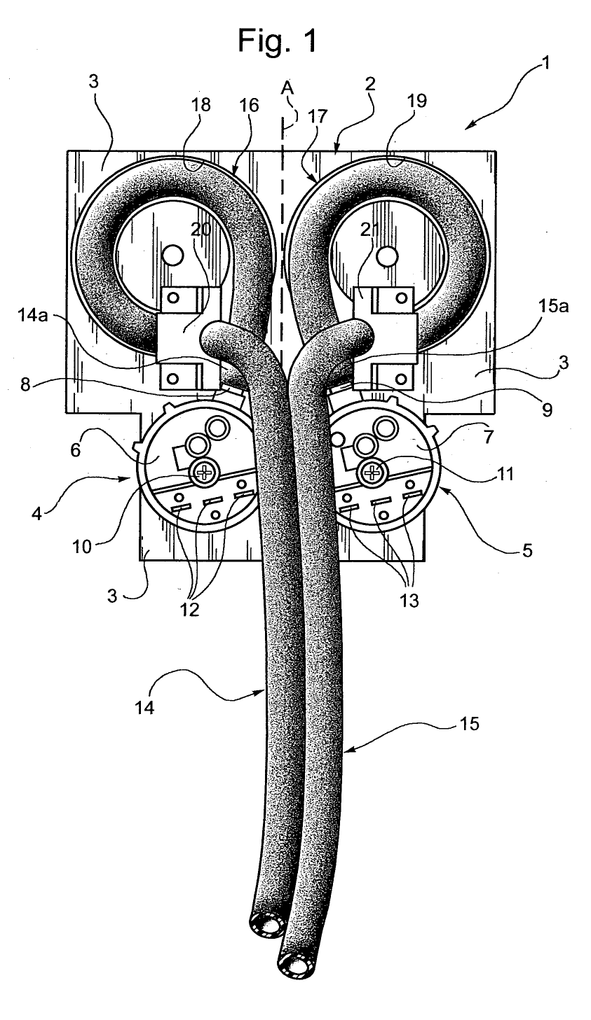

In FIG. 1, the reference 1 indicates as a whole an electrical sensor device for the level of the washing water according to the invention for use in a washing machine of a type that is known per se, in particular in a dish-washing machine (not illustrated).

The device 1 has a support structure indicated as a whole by 2, comprising a shaped plate-like body 3, for example of moulded plastics material, intended to be arranged operatively in a substantially vertical position.

In the exemplary embodiment illustrated, the sensor device 1 is of the so-called two-level type, inasmuch as it is suitable for providing two different signals when the water in the washing chamber or tub of the machine reaches a first and respectively a second predetermined level. However, the scope of the present invention includes a sensor device with a single signalling threshold or level and therefore having a substantially “halved” structure with respect to that which will now be described with reference to the drawing.

In FIG. 1, the references 4 and 5 indicate as a whole two electrical air pressure threshold sensors, of a type known per se, also commonly called “pressure switches” having one level. The sensors comprise respective bodies 6 and 7, for example of moulded plastics material, having respective tubular inlet connectors 8 and 9 for an air pressure to be detected.

The pressure sensor devices 4 and 5 are for example of the diaphragm type, and have respective adjusting screws 10 and 11, for the adjustment of the respective intervention thresholds. The sensors further have respective electrical terminals 12 and 13, for connection to a control unit for controlling the operation of the washing machine.

The aforesaid sensors 4 and 5, in operation, provide respective electrical signals when the air pressures at the respective inlet connectors 8 and 9 exceed the threshold values respectively set for them.

The references 14 and 15 indicate two lengths of flexible tube, for example made of rubber or plastics material, having respective first ends 14a and 15a coupled to the inlet connectors 8 and respectively 9 of the pressure sensors 4 and 5.

Starting from the connectors 8 and 9 of the sensors 4 and 5, the lengths of flexible tube 14 and 15 are curved so as to form respective loops 16 and 17 which extend higher than the bodies 6 and 7 of the aforesaid pressure sensors 4 and 5. The loops 16 and 17 are conveniently substantially in the shape of annular loops, and the portions of the lengths of tube 14 and 15 which are directed downwards, or towards the washing chamber or tub (not shown) of the machine, pass close to the inlet connectors 8 and 9 of the associated pressure sensors 4 and 5.

Preferably, as shown in the drawing, the bodies 6 and 7 of the pressure sensors 4 and 5 are fixed to the support structure 2 in such a way that the axes of their inlet connectors 8 and 9 form an angle with respect to the vertical. The angle may conveniently be between 15° and 35°.

The flexible tubes 14 and 15 extend, in a manner not shown, towards the washing chamber or tub of the machine, in such a way that when the level of the washing water in the chamber or tub increases, the water is capable of causing air to be trapped in their interior. As the level of the washing water increases, the pressure of the air trapped in the tubes 14 and 15 increases, and when the air pressures at the inlets 8 and 9 of the sensors 4 and 5 exceed respective threshold values, the sensors 4 and 5 provide their respective signals. To the threshold pressures of the sensors 4 and 5 there correspond predetermined levels of the water in the washing chamber or tub.

Preferably, in the plate-like body 3 of the support structure 2 quasi-annular grooves or hollows 18 and 19, for example of semicircular cross-section, are formed, in order to receive at least partly the portions of the lengths of tube 14 and 15 which form the aforesaid loops 16 and 17.

In the embodiment illustrated, each length of flexible tube 14, 15 is fixed to the plate-like body 3 by means of a respective retaining member 20, 21 secured to the plate-like body for example by means of screws or rivets. Each member 20, 21 extends transversely straddling the respective length of tube 14, 15, on the opposite side from the plate-like body 3 with respect to the associated length of tube.

In an alternative embodiment, not illustrated, the retaining and locking member or members 20 and 21 are made in one piece with the plate-like body 3.

In the embodiment illustrated, the lengths of tube 14 and 15 conveniently form the respective loops 16, 17, following paths that are symmetrical relative to a vertical plane intermediate between the sensors 4 and 5, the line of which is partly shown by dashed lines and indicated by A in the drawing. The portions of the lengths of tube 14, 15 which are directed towards the washing chamber or tub of the machine conveniently extend adjacent to each other.

The electrical sensor device for the level of the washing water in a washing machine according to the invention can be produced in a simple and economic manner, and is suitable for operating in a location in which its threshold pressure sensor or sensors are placed at a lower level than the maximum level that can be reached by the water in the washing chamber or tub. Under such conditions, the loops 16 and 17 formed by the flexible tubes 14 and 15 act completely as siphons.

The invention naturally extends to all the embodiments which achieve equal usefulness owing to the same innovative concepts.

What is claimed is:

1. An electrical sensor device for the level of the washing water in a washing machine, in particular in a dish-washing machine, comprising
at least one electrical air pressure threshold sensor, with a body which has an inlet connector for an air pressure to be detected, and capable of providing an electrical signal when said air pressure exceeds a predetermined threshold value;
a support structure intended to be fixed in the machine, and to which the body of said pressure sensor is fixed; and
at least one duct having one end coupled to the inlet connector of the pressure sensor, and the other end extending into the washing chamber or tub of the machine in such a way that when the level of the washing water in said chamber or tub increases, said water is capable of causing air to be trapped in said duct;
said at least one duct comprising a length of flexible tube, coupled to the inlet connector of the associated pressure sensor and curved and joined to said support structure in such a way as to form a loop which extends higher than the body of the pressure sensor, and which then continues downwards in the direction of the washing chamber or tub.

2. A device according to claim 1, wherein the body of the pressure sensor is fixed to the support structure in such a way that the axis of its inlet connector forms an angle with respect to the vertical.

3. A device according to claim 1, wherein said length of flexible tube forms substantially an annular loop and the portion of said length of tube which is directed towards the washing chamber or tub passes close to the inlet connector of the associated pressure sensor.

4. A device according to claim 1, wherein said support structure comprises a plate-like body intended to be arranged operatively in a substantially vertical position, and wherein a groove is formed, capable of receiving at least partly the portion of the length of flexible tube which forms the aforesaid loop.

5. A device according to claim 1, wherein the or each length of flexible tube is fixed to the support structure by means of a retaining member which is secured to said structure and which extends transversely to the associated tube on the opposite side from the support structure with respect to said tube.

6. A device according to claim 5, wherein the retaining member or members are produced in one piece with said support structure.

7. A device according to claim 5, wherein the retaining member or members are separate and distinct from said support structure and are connected thereto by means of fixing members, such as screws or rivets.

8. A device according to claim 1, comprising a pair of threshold pressure sensors, having respective different threshold pressure values, and fixed to said support structure in a horizontally side by side relationship and to the inlet connectors of which are coupled respective lengths of flexible tube curved in such a way as to form respective loops above the bodies of the corresponding sensors.

9. A device according to claim 8, wherein the inlet connectors of the two pressure sensors extend upwards, in proximity to each other, and the lengths of flexible tube associated therewith form the respective loops, following paths that are symmetrical relative to a vertical plane intermediate between the two sensors.

10. A device according to claim 9, wherein the portions of the two lengths of flexible tube that are directed or turned towards the washing chamber or tub extend adjacent to each other.
